(19) United States
(12) Patent Application Publication
(10) Pub. No.: US 2009/0278282 A1
(43) Pub. Date: Nov. 12, 2009

(54) INSERT-MOLDED COVER AND METHOD FOR MANUFACTURING SAME

(75) Inventors: HAN-MING LEE, Tu-Cheng (TW); CHIH-CHIEN HUNG, Tu-Cheng (TW); HSIANG-SHENG CHOU, Tu-Cheng (TW); CHING-HSIEN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/187,394

(22) Filed: Aug. 7, 2008

(30) Foreign Application Priority Data
May 9, 2008 (CN) 200810301532.3

(51) Int. Cl. B29C 45/14; H01Q 13/00

(52) U.S. Cl. 264/272.11; 29/600

(57) ABSTRACT

The present invention relates to an insert-molded cover (10) for electronic devices. The insert-molded cover includes a metallic body (11) and a plastic antenna lid (12) integrally formed with the metallic body. The metallic body includes a joining area (13) on an edge of the metallic body, the plastic antenna lid includes at least two portions (12a, 12b) formed in the joining area correspondingly. The present invention also relates to a method for manufacturing an insert-molded cover for electronic devices.

### CROSS-REFERENCE TO RELATED APPLICATIONS

This application is related to five co-pending U.S. patent applications, applications Ser. No. 12/171271, Ser. No. [to be advised] (Docket No. US20076), Ser. No. [to be advised] (Docket No. US20236), Ser. No. [to be advised] (Docket No. US20421), and all entitled “INSERT-MOLDED COVER AND METHOD FOR MANUFACTURING SAME”; applications Ser. No. [to be advised] (Docket No. US20071), entitled “JOINING STRUCTURE AND INSERT-MOLDED COVER USING SAME”. In the co-pending applications, the inventors are Han-Ming Lee, Chih-Chien Hung, Hsiang-Sheng Chou and Ching-Hsien Chang. Such applications have the same assignee as the present application and have been concurrently filed herewith. The disclosures of the above identified applications are incorporated herein by reference.

### BACKGROUND OF THE INVENTION

1. Field of the Invention

The present invention relates to insert-molded covers and, more particularly, to an insert-molded cover used for an electronic device and a method for manufacturing the insert-molded cover.

2. Discussion of the Related Art

Electronic devices, such as notebook computers, mobile phones, or personal digital assistants (PDAs), are very popular and widely used. Covers of electronic devices are generally made of two kinds of materials, plastic and metal. Generally, a metallic cover has a nicer appearance and a better surface feeling than a plastic one, thus metallic covers for electronic devices are now becoming more and more popular.

Because the metal has a good electromagnetic shielding capability, a portion of the cover corresponding to an antenna of an electronic device is made of plastic, so that signals can be received and transmitted through the plastic portion, and certain functions would not be weaken by electromagnetic shielding. A typical metallic cover includes a metallic body and a plastic antenna lid. The plastic antenna lid is substantially an elongated plate and integrally formed with the metallic body by insert molding technology. However, the plastic materials have a shrinkage character, especially, if a product made of plastic materials has an elongated shape, the shrinkage character is obvious. Thus, when cooling the mold, the plastic antenna lid is easily deformed, because of shrinking. In addition, if the plastic antenna lid is deformed, a strong internal stress would exist in the plastic antenna lid. In using the metallic cover, the plastic antenna lid would crack or warp when the internal stress is released due to a sharp change of temperature or when hit by an external force. Therefore, the mechanical strength and durability of the metallic cover is relatively compromised.

What is needed, therefore, is a new insert-molded cover that overcomes the above mentioned disadvantages.

### SUMMARY

In one aspect, an insert-molded cover, used for electronic devices, includes a metallic body, a plastic antenna lid integrally formed with the metallic body. The metallic body includes a joining area on an edge of the metallic body, the plastic antenna lid includes at least two portions formed in the joining area respectively.

In another aspect, a method for manufacturing an insert-molded cover includes following steps. Firstly, a metallic body is manufactured, the metallic body has a joining area on an edge of the metallic body. Secondly, a plastic antenna lid is molded on the metallic body by insert molding, the plastic antenna lid includes at least two portions formed in the joining area respectively.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present insert-molded cover for electronic devices. Moreover, in the drawings, like reference numerals designate corresponding parts throughout the several views.

FIG. 1 is an exploded, isometric view of an insert-molded cover in accordance with a first preferred embodiment of the present invention.

FIG. 2 is an isometric view of the insert-molded cover in FIG. 1.

FIG. 3 is an exploded, isometric view of an insert-molded cover in accordance with a second preferred embodiment of the present invention.

FIG. 4 is an isometric view of the insert-molded cover in accordance with a third preferred embodiment of the present invention.

FIG. 5 is an isometric view of the insert-molded cover in accordance with a fourth preferred embodiment of the present invention.

FIG. 6 is an isometric view of the insert-molded cover in accordance with a fifth preferred embodiment of the present invention.

### DETAILED DESCRIPTION OF THE EMBODIMENTS

Reference will now be made to the drawings to describe preferred embodiments of the present insert-molded cover, in detail. The insert-molded cover is used for electronic devices such as notebook computers, and mobile phones.

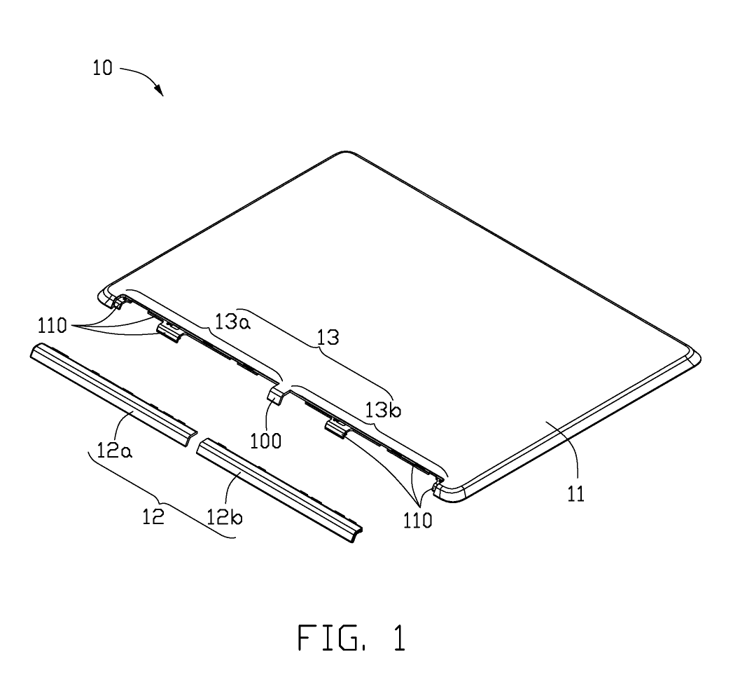

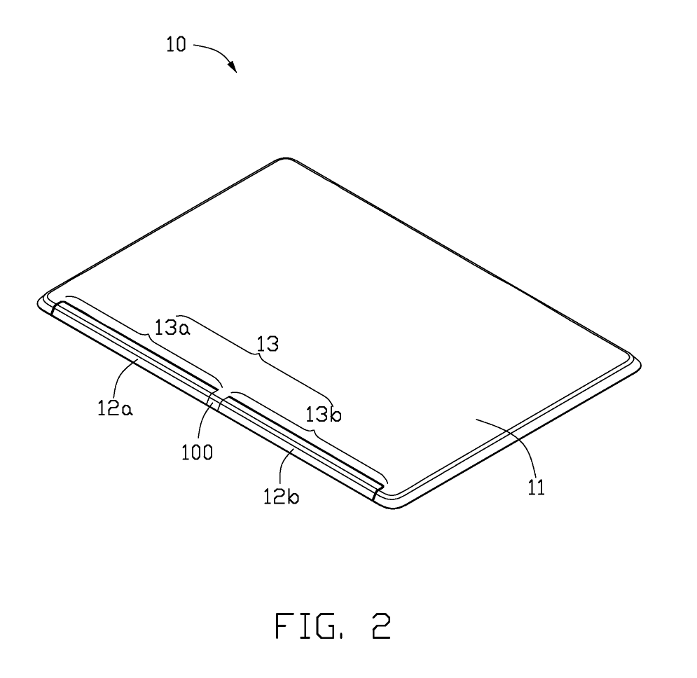

Referring to FIGS. 1 and 2, an insert-molded cover 10 for electronic devices according to a first preferred embodiment is shown. The insert-molded cover 10 includes a metallic body 11 and a plastic antenna lid 12.

The metallic body 11 is substantially a rectangular plate made of alloy, and the alloy is preferably magnesium alloy, aluminum alloy or titanium alloy. A partition portion 100 and a plurality of latching portions 110 are disposed on an edge of the metallic body 11. The metallic body 11 includes a joining area 13 formed on the edge adjoining the partition portion 100 and the latching portions 110. The partition portion 100 is positioned in the middle of the joining area 13 for separating the joining area 13 into two separate areas, a first joining area 13a and a second joining area 13b.

The plastic antenna lid 12 includes a first plastic antenna lid 12a and a second plastic antenna lid 12b. The first and second plastic antenna lids 12a and 12b are formed in the first and second joining areas 13a, 13b respectively. The partition portion 100 is positioned between the first and second plastic antenna lids 12a and 12b. A thickness of the partition portion 100 equals to that of the first and second plastic antenna lids 12a and 12b, such that the partition portion 100 and the first and second plastic antenna lids 12a and 12b are joined uniformly. At the same time, the plastic antenna lid 12 is latched with the latching portions 110 of the metallic body 11 in a molding process.

The material of the plastic antenna lid 12 should have a property of good bonding ability with the material of the metallic body 11. In other words, the material of the plastic antenna lid 12 should have a low shrinkage and a similar linear expansion with the material of the metallic body 11. Thus, the material of the plastic antenna lid 12 is selected from the group consisting of liquid crystal polymer(LCP), polyphenylene sulphide(PPS), polybutylene terephthalate(PBT) and their combination.

A method for manufacturing the insert-molded cover 10 includes following steps.

Firstly, a metallic body 11 is manufactured, the metallic body 11 has a partition portion 100 and a plurality of latching portions 110 formed on an edge of the metallic body 11. The metallic body 11 also has a joining area 13 on the edge adjoining the partition portion 100 and the latching portions 110. The partition portion 100 is positioned in the middle of the joining area 13 for separating the joining area 13 into two separate areas, a first joining area 13a and a second joining area 13b. The metallic body 11 is manufactured by casting, forging, or extrusion molding methods. The partition portion 100 and the plurality of latching portions 110 are formed by a computerized numerical control (CNC) equipment. Alternatively, the partition portion 100 and the plurality of latching portions 110 are integrally formed with the metallic body 11 by casting.

Secondly, a plastic antenna lid 12 is molded on the metallic body 11 by insert molding. The plastic antenna lid 12 includes a first plastic antenna lid 12a and a second plastic antenna lid 12b that are formed in the first and second joining areas 13a and 13b respectively. In detail, the metallic body 11, as an insert member, is placed into an injection mold, then melted plastic is injected into the injection mold. The first and second joining areas 13a and 13b are filled with the melted plastic, correspondingly. After the melted plastic is cooled, the first and second plastic antenna lid 12a and 12b are formed on two sides of the partition portion 100 correspondingly. At the same time, the plastic antenna lid 12 is latched with the latching portions 110 for firmly joining with the metallic body 11.

In this preferred embodiment, the partition portion 100 divides the plastic antenna lid 12 into two separate portions, i.e., the first and second plastic antenna lid 12a and 12b. The shrinkage of each of the first and second plastic antenna lids 12a and 12b is much less than the shrinkage of an otherwise elongated one-piece plastic antenna lid. Therefore, the shrinkage deformation of the plastic antenna lid 12 is very small and can be negligible. The statistic data showed that, the middle portion of an integrally elongated one-piece plastic antenna lid has a serious deformation, and the largest deformation amount could be 0.8% of the length of an elongated one-piece plastic antenna lid. However, the largest deformation amount of each of the first and second plastic antenna lids 12a and 12b is less then 0.2% of the length of the plastic antenna lid 12. Correspondingly, an internal stress of the first and second plastic antenna lids 12a and 12b is very small. Even when the internal stress is released due to a sharp change of temperature or when hit by an external force, the plastic antenna lid 12 seldom cracks or warps. Therefore, the mechanical strength and durability of the insert-molded cover 10 is enhanced.

The length of each of the first and second plastic antenna lids 12a and 12b is determined by an allowable largest deformation amount of the insert-molded cover 10. For example, if the allowable largest deformation amount of the insert-molded cover 10 is 0.8 millimeters, and the shrinkage of the plastic is about 0.3%. The length of each of the first and second plastic antenna lids 12a and 12b is a ratio of the allowable largest deformation amount with respect to the shrinkage of the plastic, that is, 267 millimeters.

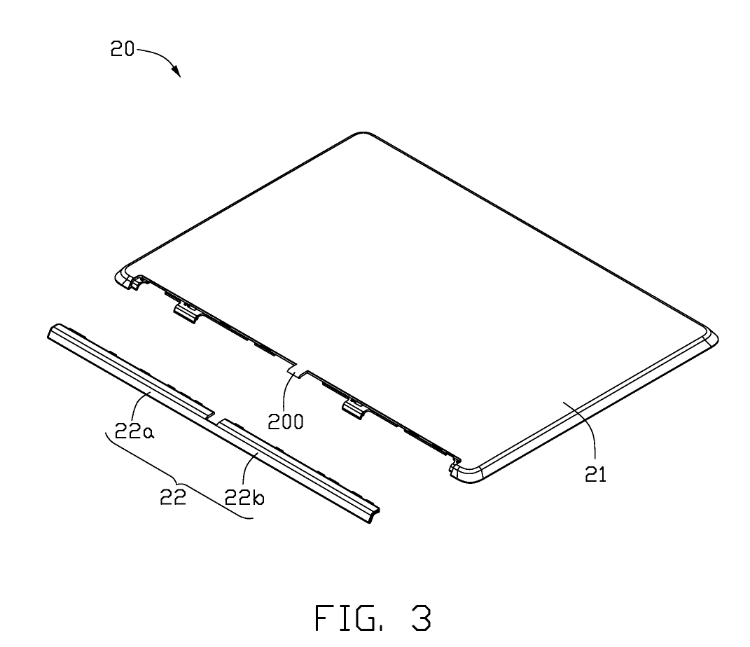

Referring to FIG. 3, an insert-molded cover 20 in accordance with a second preferred embodiment of the present invention is shown. The insert-molded cover 20 is similar in principle to the insert-molded cover 10 of the first embodiment. However, a partition portion 200 is configured to be partially embedded into a plastic antenna lid 22, thus a first plastic antenna lid 22a and a second plastic antenna lid 22b are partially connected. A method for manufacturing the insert-molded cover 20 is substantially same as the method for manufacturing the insert-molded cover 10.

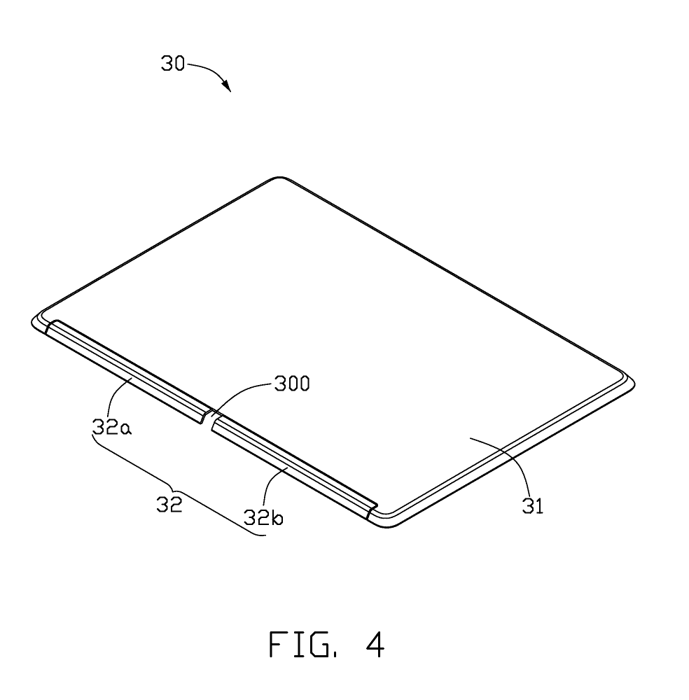

Referring to FIG. 4, an insert-molded cover 30 in accordance with a third preferred embodiment of the present invention is shown. The insert-molded cover 30 is similar in principle to the insert-molded cover 10 of the first embodiment. However, the partition portion is omitted, a notch 300 is defined in the middle of a plastic antenna lid 32 thereby divides the plastic antenna lid 32 into two separate portions; a first plastic antenna lid 32a and a second plastic antenna lid 32b.

To manufacture the insert-molded cover 30, the metallic body 31, as an insert member, is placed into an injection mold, the injection mold includes a block portion formed on a middle of an inner-surface of the injection mold. Then a melted plastic is injected into the cavity of the injection mold from two sides of the block portion, respectively. After the melted plastic is cooled and the mold is unloaded, the plastic antenna lid 32 is separated into the first and second plastic antenna lid 32a, 32b by a notch 300. Alternatively, a cutting mechanism is disposed on an injection mold and melted plastic is injected into the cavity of the injection mold. After the melted plastic is semi-solidified, the melted plastic is cut to form a notch 300 in a middle portion via the cutting mechanism, thus the plastic antenna lid 32 is separated into the first and second plastic antenna lid 32a and 32b by the notch 300. Because the notch 300 is defined between the first and second plastic antenna lids 32a and 32b, when in high temperatures the notch 300 defines a buffer room for the first and second plastic antenna lids 32a, 32b to expand. Thus, the thermal expansion of the first and second plastic antenna lids 32a and 32b would not cause a deformation of the insert-molded cover 30. Therefore, the insert-molded cover 30 not only has a low shrinkage, but also has a high heat resistance.

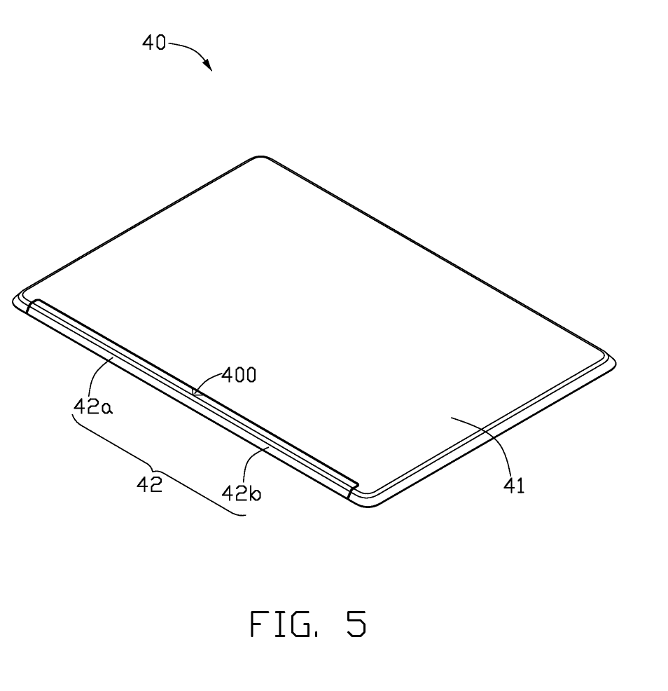

Referring to FIG. 5, an insert-molded cover 40 in accordance with a fourth preferred embodiment of the present invention is shown. The insert-molded cover 40 is similar in principle to the insert-molded cover 30 of the third embodiment. However, the plastic antenna lid 42 is separated by a V-shaped cut 400. The V-shaped cut 400 only partially extends into the plastic antenna lid 42, thus the first plastic antenna lid 42a and the second plastic antenna lid 42b are partially connected. A method for manufacturing the insert-molded cover 40 is substantially same as the method for manufacturing the insert-molded cover 30.

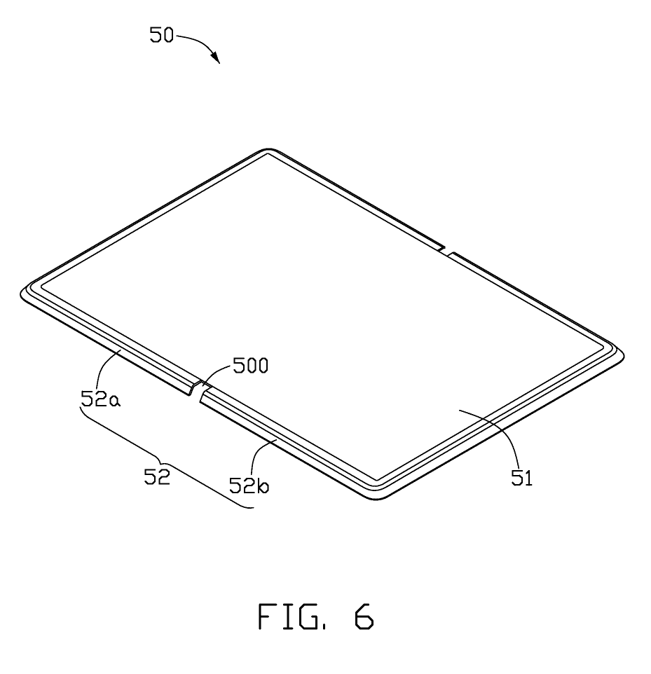

Referring to FIG. 6, an insert-molded cover 50 in accordance with a fifth preferred embodiment of the present invention is shown. The insert-molded cover 50 includes a metallic body 51 and a plastic antenna lid 52 formed around a periphery of the metallic body 51. Two notches 500 extend through the two sides of the plastic antenna lid 52 and separate the plastic antenna lid 52 into two separate portions, the first plastic antenna lid 52a and the second plastic antenna lid 52b.

It should be understood that, the plastic antenna lids 12, 22, 32, 42 and 52 can be separated into a plurality of portions respectively, such as three portions, four portions, and so on. The insert-molded cover 10, 20, 30, 40 and 50 can be used in other products, besides electronic devices.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An insert-molded cover, used for electronic devices, the insert-molded cover comprising:
a metallic body including a joining area on an edge of the metallic body; and
a plastic antenna lid integrally formed with the metallic body, the plastic antenna lid including at least two portions formed in the joining area respectively.

2. The insert-molded cover as claimed in claim 1, wherein the metallic body is a rectangular plate made of a material selected from the group consisting of magnesium alloy, aluminum alloy and titanium alloy.

3. The insert-molded cover as claimed in claim 1, wherein the metallic body comprises at least one partition portion disposed in the joining area for separating the joining area into at least two separate areas, and each of the at least two portions of the plastic antenna lid is formed in one of the at least two separate areas respectively.

4. The insert-molded cover as claimed in claim 3, wherein each of the at least one partition portions completely protrudes through the plastic antenna lid, thus each of the at least two portions of the plastic antenna lid is separate.

5. The insert-molded cover as claimed in claim 3, wherein each of the at least one partition portion is partially embedded into the plastic antenna lid, thus the at least two portions of the plastic antenna lid are partially connected.

6. The insert-molded cover as claimed in claim 1, wherein at least one notch is defined in the plastic antenna lid thereby separating the plastic antenna lid into the at least two separate portions.

7. The insert-molded cover as claimed in claim 1, wherein each of the at least two portions of the plastic antenna lid is separated by at least one V-shaped cut, each of the at least one V-shaped cut only partially extends into the plastic antenna lid, thus the at least two portions of the plastic antenna lid are partially connected.

8. The insert-molded cover as claimed in claim 1, wherein the plastic antenna lid is formed around a periphery of the metallic body, and the plastic antenna lid is separated by two notches, the two notches completely extend through two sides of the plastic antenna lid, thus each of the at least two portions of the plastic antenna lid is separate.

9. The insert-molded cover as claimed in claim 2, wherein the metallic body comprises a plurality of latching portions disposed on the edge of the metallic body, the plastic antenna lid is latched with the latching portions for firmly joining with the metallic body.

10. The insert-molded cover as claimed in claim 1, wherein the material of the plastic antenna lid is selected from the group consisting of liquid crystal polymer, polyphenylene sulphide or polybutylene terephthalate and their combination.

11. A method for manufacturing an insert-molded cover for electronic devices, comprising:
manufacturing a metallic body, the metallic body including a joining area on an edge of the metallic body; and
molding a plastic antenna lid on the metallic body by insert molding, the plastic antenna lid including at least two portions formed in the joining area respectively.

12. The method for manufacturing an insert-molded cover as claimed in claim 1 1, wherein the metallic body is manufactured by casting, forging, or extrusion molding methods.

13. The method for manufacturing an insert-molded cover as claimed in claim 11, wherein the metallic body comprises a partition portion disposed in the middle of the joining area for separating the joining area into two separate portions, a first joining area and a second joining area; when molding the plastic antenna lid, the first and second joining areas are filled with the melted plastic correspondingly, thus forming the at least two portions of the plastic antenna lid.

14. The method for manufacturing an insert-molded cover as claimed in claim 13, wherein the partition portion is formed by a computerized numerical control equipment.

15. The method for manufacturing an insert-molded cover as claimed in claim 13, wherein the partition portion is integrally formed with the metallic body by casting.

16. The method for manufacturing an insert-molded cover as claimed in claim 11, wherein the metallic body is placed into an injection mold as an insert member, the injection mold includes a block portion formed on a middle of an inner-surface of the injection mold; when molding the plastic antenna lid, the melted plastic is injected into the cavity of the injection mold from two sides of the block portion respectively, thus forming the at least two portions of the plastic antenna lid.

17. The method for manufacturing an insert-molded cover as claimed in claim 11, wherein the metallic body is placed into an injection mold as an insert member, the injection mold has a cutting mechanism disposed on an injection mold, a melted plastic is injected into the cavity of the injection mold; after the melted plastic is semi-solidified, the melted plastic is cut to form a notch in a middle portion via the cutting mechanism, thus forming the at least two portions of the plastic antenna lid.
